(19) United States
(12) Patent Application Publication
(10) Pub. No.: US 2023/0018066 A1
(43) Pub. Date: Jan. 19, 2023

(54) APPARATUS AND SYSTEM FOR GROWTH TYPE SMART TOY

(71) Applicant: AURORA WORLD CORPORATION, Seoul (KR)

(72) Inventors: Heui Yul NOH, Seoul (KR); Sun Haeng LEE, Seoul (KR); You Jung LEE, Goyang-si (KR); Dong Young JANG, Seoul (KR); Chan Nyeong YUN, Seoul (KR); Young Ha SHIN, Seoul (KR)

(21) Appl. No.: 17/783,124

(22) PCT Filed: Nov. 23, 2020
(86) PCT No.: PCT/KR2020/016548

§ 371 Date: Jun. 7, 2022

(30) Foreign Application Priority Data
Nov. 20, 2020 (KR) 10-2020-0157045

(51) Int. Cl. A63H 3/28

(52) U.S. Cl. CPC A63H 3/28; A63H 2200/00; G16Y 10/65

(57) ABSTRACT

According to at least one aspect, the present disclosure provides a smart toy device that updates its growth stage based on the emotional state of the smart toy device and performs an expressive action corresponding to an interaction with a user in step with growth stages. According to another aspect, the present disclosure provides a smart toy system including a smart toy device, whose growth stage is updated based on the emotional state of the smart toy device, a terminal capable of transmitting and receiving messages in conjunction with the smart toy device, and a server that transmits, to the smart toy device, voice data and data related to a condition for changing the growth stage.

### TECHNICAL FIELD

The present disclosure in some embodiments relates to a growth-type smart toy device and a smart toy system.

### BACKGROUND

The statements in this section merely provide background information related to the present disclosure and do not necessarily constitute prior art.

Smart toys are actively developed in recent years. A smart toy refers to a toy incorporating information and communication technologies (ICT) such as artificial intelligence or the Internet of Things (IoT). Such a smart toy, for example, is good for supporting the emotional and educational development of infants-toddlers by supporting a communication function with them or supporting the intellectual development of infants-toddlers with the support of a very sophisticated control function like a robot.

However, the existing smart toys have garnered a limited degree of interest. For example, conventional smart toys for infants-toddlers and children with a rapid growth rate suffer from the lost interest of their users as quickly as they grow.

Therefore, a need arises for an advanced smart toy that can variably adapt to the growth stage of the user.

### PRIOR ART LITERATURE

### Patent Documents

(Patent document 1) Korean Patent Application Publication No. 10-2018-0130903 (published May 30, 2017)

(Patent document 2) Korean Patent Application Publication No. 10-2001-0104847 (published Nov. 28, 2001)

### DISCLOSURE

### Technical Problem

According to at least one aspect, the present disclosure seeks to provide a smart toy device that updates its growth stage based on the emotional state of the smart toy device and performs an expressive action corresponding to an interaction with a user in step with growth stages.

According to another aspect, the present disclosure aims to provide a smart toy system including a smart toy device, whose growth stage is updated based on the emotional state of the smart toy device, a terminal capable of transmitting and receiving messages in conjunction with the smart toy device, and a server that provides the smart toy device with voice data or data related to a condition for changing the growth stage.

### SUMMARY

According to at least one aspect, the present disclosure provides a smart toy device having an emotional state and a growth stage, including an emotion unit, a growth unit, a message unit, and an output unit. The emotion unit is configured to update the emotional state based on an interaction with a user. The growth unit is configured to update the growth stage according to an accumulated frequency of the emotional state or an accumulated time of interaction with the user. The message unit is configured to transmit and receive a voice message or a text message to and from a terminal or other smart toy. The output unit is configured to output an expressive action corresponding to the interaction or transmit a message received by the message unit by a voice of a voice type determined based on the emotional state or the growth stage.

According to other aspects, the present disclosure provides the smart toy device that further includes one or more character skins of preset types attached to the smart toy device. The present disclosure provides the smart toy device with the voice type changed based on the emotional state or the growth stage into a voice of a character corresponding to a changed character skin when the character skins are switchably attached.

According to yet another aspect, the present disclosure provides a smart toy system including a smart toy device, a terminal, and a server. The smart toy device, having a growth stage that is updated, is configured to vocally output, based on the growth stage, an expressive action corresponding to an interaction with a user. The terminal is configured to interwork with the smart toy device and to transmit and receive a voice message or a text message. The server is configured to transmit, to the smart toy device, all or some voice data and data related to a condition for changing the growth stage in response to a request of the smart toy device.

### Advantageous Effects

As described above, according to at least one aspect, the present disclosure can provide a smart toy device that updates its growth stage based on the emotional state of the smart toy device and performs an expressive action corresponding to an interaction with the user in step with the growth stages.

According to another aspect, the present disclosure can provide a smart toy system including a smart toy device, whose growth stage is updated based on the emotional state of the smart toy device, a terminal capable of transmitting and receiving messages in conjunction with the smart toy device, and a server that provides the smart toy device with voice data or data related to a condition for changing the growth stage.

Therefore, according to various aspects of the present disclosure, the smart toy device and the smart toy system that are capable of variably adapting to the growth stage of the user, effect a long-lasting interest of the user in the smart toy product.

### BRIEF DESCRIPTION OF THE DRAWINGS

FIG. 1 is a conceptual diagram of a smart toy system to which a smart toy device is applied according to at least one embodiment of the present disclosure.

FIG. 2 is a block diagram of a smart toy device according to at least one embodiment of the present disclosure.

FIG. 3 is a diagram illustrating the example growth stages of a smart toy device according to at least one embodiment of the present disclosure.

FIG. 4 is a flowchart of a messaging function performed by using a smart toy device according to at least one embodiment of the present disclosure.

REFERENCE NUMERALS

| | |
|---|---|
| 200: smart toy device | 202: emotion unit |
| 204: growth unit | 206: message unit |
| 208: output unit | 210: character skin |

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The description of the present disclosure to be presented below in conjunction with the accompanying drawings is intended to describe exemplary embodiments of the present disclosure and is not intended to represent the only embodiments in which the technical idea of the present disclosure may be practiced.

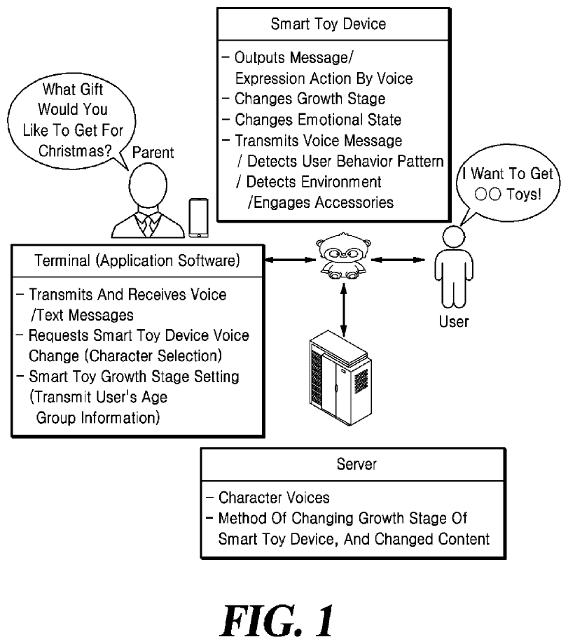

FIG. 1 is a conceptual diagram of a smart toy system to which a smart toy device is applied according to at least one embodiment of the present disclosure.

A smart toy device according to at least one embodiment of the present disclosure has an emotional state(s) and a growth stage(s) and changes its growth stage based on the accumulated frequency of a specific emotional state and/or the accumulated time of interaction with a user.

The emotional state of the smart toy device is changed based on interaction with the user. According to the interaction with the user, the smart toy device may vocally output a preset expression motion(s) or expressive action(s). For example, when the user lifts the smart toy device upside down, the smart toy device may output a voice indicating that it is dizzy as an expressive action.

The smart toy device transmits and receives a voice message or a text message to and from another smart toy device or terminal or a terminal installed with a software application capable of controlling the smart toy device. In this case, the smart toy device may be responsive to when the received message is a text message for converting and outputting the same into a voice message by using a Text To Speech (TTS) module or the like. This has the effect of easily exchanging messages with infants-toddlers and children, people with visual impairments, and the elderly who have difficulty understanding text messages.

The smart toy device's outputted voice of the expressive action and/or the voice message may be a voice of a character corresponding to a character's skin when provided as an attachment to the smart toy device. The content of the voice outputted by the smart toy device or the very voice may be content corresponding to the growth stage of the smart toy device or a voice modulated to correspond to the growth stage of the smart toy device. This voice is preferably a voice that has been further modulated to correspond to the emotional state of the smart toy device.

The smart toy device may obtain information on the interaction with the user from all or some of its installed devices including a hall sensor, a photo register, an acceleration sensor, a tilt sensor, a microphone, a magnetic switch, and a tact switch (which are not shown individually), and thereby detect an interaction type or user behavior pattern, or detect the surrounding environment of the smart toy device to change the emotional state and/or the growth stage of the smart toy device according to the interaction.

The smart toy device may be provided with an accessory attachment (not shown) such as an eye patch, comb, baby bottle, rattle, etc., wherein it can change the emotional state or perform a relevant expressive action based on this attachment. For example, when an eye patch is attached to the smart toy device and the user lays down the smart toy device, it may output a sleeping sound effect such as a snoring sound.

Users may engage the smart toy device to transmit a voice message to another smart toy device or a terminal interworking with the smart toy device. Such a voice message may be transmitted by using, for example, the terminal as a response message, e.g., “I want to receive OO toys!” in FIG. 1 to a message, e.g., “What kind of gift do you want to get for Christmas?” in FIG. 1 received from another user, e.g., a parent in FIG. 1. The smart toy device may be responsive to the received message when ending with a question mark, or when the received message is a text message ending with question mark punctuation or the text message includes question mark punctuation for outputting the received message to the user by voice and then requesting and relaying its response message to another user.

The terminal interlocked with the smart toy device may transmit and receive a voice message or text message to and from the smart toy device, and it may request the smart toy device to change the voice type of the smart toy device or request the same to change the growth stage of the smart toy device. For example, the terminal may request the smart toy device to output a voice of any one of the preset types of characters from the smart toy device, and it may determine the type of voice for the smart toy device to output by transmitting, to the smart toy device, a user's age group information, user gender information, etc. which have been inputted to the terminal.

The smart toy device may receive (or download) data from a server, such as voice data, e.g., voice data of a specific character, data on the growth stage of the smart toy device, or data on its emotional state for allowing the smart toy device to be customized with a new growth stage algorithm or an emotional state algorithm applied to the received data items, or with a new unset type of character's voice applied to the smart toy device. Here, the data on the growth stage may be an algorithm that defines different growth stages and conditions leading to each growth stage for changing the growth stage of the smart toy device. Additionally, the data on its emotional state may be an algorithm defining different emotional states and conditions to correspond to each emotional state for changing the emotional state of the smart toy device.

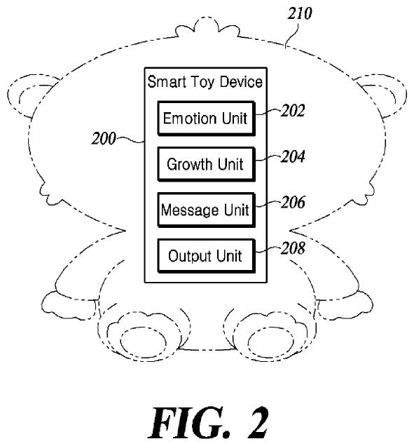

FIG. 2 is a block diagram of a smart toy device 200 according to at least one embodiment of the present disclosure.

The smart toy device 200 according to at least one embodiment includes an emotion unit 202, a growth unit 204, a message unit 206, an output unit 208, and a character skin 210 in whole or in part. The smart toy device 200 shown in FIG. 2 is according to at least one embodiment of the present disclosure, and not all components shown in FIG. 2 are requisite components, and some components may be added, changed, or deleted in other embodiments. For example, in another embodiment, the smart toy device may further include a modulation unit (not shown) for storing and learning the user's voice and modulating the voice(s) of the expressive action and/or the received voice message with the user's voice.

FIG. 2 shows the smart toy device 200 as a hardware device for convenience of description, although another embodiment can implement the smart toy device as a software module or processor that performs the functions of the respective components 202 to 208.

The emotion unit 202 updates the emotional state of the smart toy device 200 based on the interaction with the user. The emotion unit 202 may obtain information on interactions with the user from one or more sensors attached to the smart toy device 200 by, for example, perceiving a voice input by using the microphone, detecting motions such as tilting or laying down the smart toy device with the tilt sensor or detecting the smart toy device wearing an eye patch as an accessory with the photo register, detecting shaking with the acceleration sensor, and detecting attachment of other accessories by using the Hall sensor or magnetic switch. The emotion unit 202 may use the obtained interaction information as a basis for determining whether a preset condition is satisfied for switching between emotional states and thereby updating the emotional state of the smart toy device 200. Since the emotion unit 202 may detect a plurality of interactions from a plurality of sensors at the same time or within a preset time, those conditions for switching between emotional states may be set based on information on the plurality of interactions.

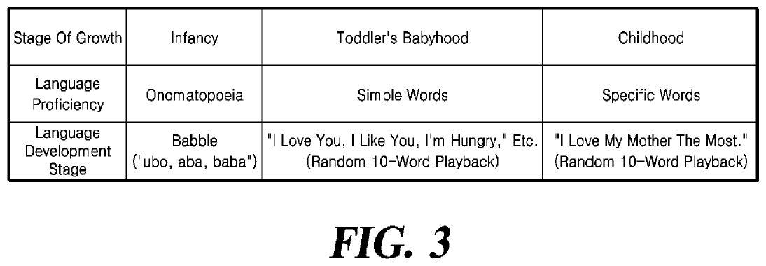

The growth unit 204 updates the growth stage according to the accumulated frequency of an emotional state or the accumulated time of interaction with the user. The update of the growth stage may be performed, for example, by further receiving the age group information of the user, and further taking into account the age group information of the user in each accumulated frequency of one or more emotional states or at each accumulated time of interaction of one or more emotional states with the user. The growth stages of the smart toy device 200 and the update of the growth stage will be detailed below by referring to FIG. 3.

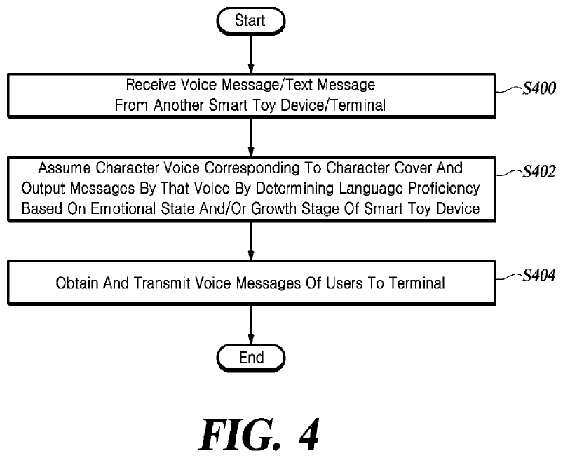

The message unit 206 transmits and receives a voice message or text message with another smart toy device or terminal. Detailed description of message transmission and reception of the smart toy device 200 will be provided below by referring to FIG. 4.

The output unit 208 outputs the expressive action corresponding to the interaction or the message received by the message unit 206 by a voice of a voice type determined based on the emotional state or growth stage of the smart toy device 200. Such a voice type may be changed when a preset interaction occurs or by receiving voice type information from the terminal or the server. Alternatively, with character skins provided to be switchably attached to the smart toy device 200, the voice type may be changed to a voice of a character relevant to the changed character's skin. The expressive action outputted by the output unit 208 or the content of the received message may change according to the emotional state or growth stage of the smart toy device 200.

The output unit 208 may further output a sound effect corresponding to an interaction with the user.

FIG. 3 is a diagram illustrating the example growth stages of a smart toy device according to at least one embodiment of the present disclosure.

The growth stage of the smart toy device may include all or some of the detailed growth stages of infants-toddlers or children, but further include all or some of the adolescent stage, youth stage, adult stage, and elder stage.

The smart toy device outputs, based on its growth stage, an expressive action corresponding to an interaction with the user and/or a received message by a voice corresponding to the growth stage. This voice outputting is preferably performed with content modified according to the language proficiency corresponding to the growth stage of the smart toy device.

For example, as shown in FIG. 3, the growth stages of the smart toy device include infancy, toddler's babyhood, and childhood stages, in which, commonly, the language proficiency in infancy is at a level that can express only onomatopoeia, the language proficiency in babyhood is expressing up to simple words, and the language proficiency in childhood is at a level that can express even specific words.

Accordingly, when the growth stage of the smart toy device corresponds to infancy, the smart toy device outputs an expressive action or a received message by a pre-stored infant voice or an infant's voice downloaded from the server. Additionally, the smart toy device may output babbling-level expressive actions such as “ubo,” “aba,” and “baba” based on the language proficiency of infancy.

When the growth stage of the smart toy device corresponds to babyhood, the smart toy device outputs an expressive action or a received message by a pre-stored toddler's voice or a toddler's voice downloaded from the server. The smart toy device may output simple word-level expressive actions such as “I love you,” “I like you,” and “I′m hungry” based on the language proficiency of a toddler's babyhood.

When the growth stage of the smart toy device corresponds to childhood, the smart toy device outputs an expressive action or a received message by a pre-stored child's voice or a child's voice downloaded from the server. The smart toy device may output an expressive action with the ability to construct specific words and a sentence such as “I love my mother the most” based on the language proficiency of childhood.

The voices outputted by the smart toy device may include a voice preset in the smart toy device, a voice requested from the terminal, a voice downloaded from the server (e.g., a robot voice, a female voice, a male voice, etc.), a voice set to be outputted in response to a preset interaction (e.g., shaking the smart toy device, etc.), a voice of a character relevant to a character skin attached to the smart toy device, and the like.

Accordingly, each expressive action of FIG. 3 may be outputted by a preset voice or other physical quantities to the smart toy device, and this voice is preferably a voice modulated in step with the growth stages and/or emotional states of the smart toy device.

The growth stages of the smart toy device as shown in FIG. 3 are exemplary, and based on various child development theories, each growth stage and/or language proficiency corresponding to each growth stage may vary. For example, based on Vygotsky's theory of language and thought development stages, the growth stage of the smart toy device may be classified into the elementary language stage, symbolic language stage, egocentric language stage, and inner language stage, and the language proficiencies corresponding respectively to the stages may be classified into the commands of primitive language, external and social language, monologue and egocentric language, and internal language.

FIG. 4 is a flowchart of a messaging function performed by using a smart toy device according to at least one embodiment of the present disclosure.

The smart toy device receives a voice message and/or a text message from another smart toy device or terminal (S400).

The smart toy device assumes the character voice corresponding to the character cover for outputting messages by that voice by determining the language proficiency based on the emotional state and/or growth stage of the smart toy device (S402). However, since the message sender may be a familiar one to the user, e.g., mother or father, the smart toy device may be configured to output a message, if it is vocal, unaltered upon receiving from all terminals or all smart toy devices or a specific terminal or a specific smart toy device, but to output an expressive action corresponding to an interaction with the user exclusively by that character voice based on the emotional state and/or growth stage of the smart toy device.

The smart toy device transmits the voice messages of users to another smart toy device or terminal (S404). Such a voice message transmission is preferably performed when there is a control input (e.g., tact switch control, etc.) to the smart toy device, and it is self-evident that Step S404 can be performed alone even in the absence of Steps S400 and S402. For example, the smart toy device may be responsive to a control input that satisfies a preset first condition for allowing the user to select a voice message transmission target, may be responsive to a control input that satisfies a second condition for generating an expressive action that requests message recording, and may be responsive to a control input that satisfies a third condition for transmitting the recorded voice message to the selected transmission target.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Various implementations of the systems and techniques described herein can be realized by a programmable computer. Here, the computer includes a programmable processor, a data storage system (including volatile memory, nonvolatile memory, or any other type of storage system or a combination thereof), and at least one communication interface. For example, the programmable computer may be one of a server, a network device, a set-top box, an embedded device, a computer expansion module, a personal computer, a laptop, a personal data assistant (PDA), a cloud computing system, and a mobile device.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

### DESCRIPTION OF NATIONAL RESEARCH AND DEVELOPMENT SUPPORT

The present disclosure was made available under the supervision of Aurora World Corp. with the support of Korea Institute for Advancement of Technology (KIAT), an affiliate of the Ministry of Trade, Industry and Energy, the Republic of Korea through a WC300 R&D project: development of an interactive smart toy and expandable content service platform through emotion recognition and interactive technology under task serial number: S2640869.

### CROSS-REFERENCE TO RELATED APPLICATION

This application claims priority from Korean Patent Application No. 10-2020-0157045 filed on Nov. 20, 2020, the disclosure of which is incorporated by reference herein in its entirety.

1. A smart toy device having an emotional state and a growth stage, comprising:
an emotion unit configured to update the emotional state based on an interaction with a user;
a growth unit configured to update the growth stage according to an accumulated frequency of the emotional state and an accumulated time of interaction with the user;
a message unit configured to transmit and receive a voice message and a text message to and from a terminal or other smart toy; and
an output unit configured to output an expressive action corresponding to the interaction or transmit a message received by the message unit by a voice of a voice type determined based on the emotional state or the growth stage,
wherein the growth stage is implemented based on an algorithm including different growth stages and conditions leading to each different growth stage for changing the growth stage,
wherein the output unit is further configured to output the expressive action or the message received by the message unit with content modified according to the language proficiency corresponding to the growth stage.

2. The smart toy device of claim 1, wherein the emotion unit is configured to further receive and take into account an age group information of the user for updating the growth stage in the accumulated frequency of the emotional state or at the accumulated time of interaction with the user.

3. The smart toy device of claim 1, wherein the voice type is changed based on a voice type information when received from the terminal or when a preset interaction occurs.

4. The smart toy device of claim 1, further comprising:
one or more character skins of preset types attached to the smart toy device.

5. The smart toy device of claim 4, wherein the voice type is changed based on the emotional state or the growth stage into a voice of a character corresponding to a changed character skin when the character skins are switchably attached.

6. (canceled)

7. The smart toy device of claim 1, wherein the growth stage comprises stages corresponding respectively to growth stages of infants-toddlers or children, and
wherein the language proficiency comprises language proficiencies corresponding to the growth stages of the infants-toddlers or children.

8. The smart toy device of claim 1, wherein the emotion unit is configured to update the emotional state by obtaining information on the interaction with the user from all or some devices that are installed in the smart toy device, the devices comprising a hall sensor, a photo register, an acceleration sensor, a tilt sensor, a microphone, a magnetic switch, and a tact switch.

9. The smart toy device of claim 1, wherein the emotion unit is configured to update the emotional state based on the interaction with the user and based on an accessory attached to the smart toy device.

10. A smart toy system, comprising:
a smart toy device having a growth stage that is updated and configured to vocally output, based on the growth stage, an expressive action corresponding to an interaction with a user;
a terminal configured to interwork with the smart toy device and to transmit and receive a voice message or a text message; and
a server configured to transmit, to the smart toy device, all or some of voice data and data related to a condition for changing the growth stage in response to a request of the smart toy device,
wherein the growth stage is implemented based on an algorithm including different growth stages and conditions leading to each different growth stage for changing the growth stage, and updated according to an accumulated frequency of the emotional state and an accumulated time of interaction with the user,
wherein the smart toy device is further configured to receive a message from the terminal, and output the expressive action or the message received with content modified according to the language proficiency corresponding to the growth stage.
